(19) United States
(12) Patent Application Publication
(10) Pub. No.: US 2015/0253168 A1
(43) Pub. Date: Sep. 10, 2015

(54) APPARATUS AND METHOD FOR COMBINED FLOW AND THERMOGRAPHIC MEASUREMENT

(71) Applicant: SIEMENS AKTIENGESELLSCHAFT, München (DE)

(72) Inventors: Ronny Jahnke, Falkensee (DE); Tristan Sczepurek, Berlin (DE)

(21) Appl. No.: 14/432,901

(22) PCT Filed: Sep. 9, 2013
(86) PCT No.: PCT/EP2013/068589

§ 371 Date: Apr. 1, 2015

(30) Foreign Application Priority Data
Oct. 10, 2012 (EP) 12187871.4

(51) Int. Cl. G01F 1/684; G01F 1/34; G01J 5/00

(52) U.S. Cl. CPC G01F 1/6842; G01J 5/0014; G01F 1/34; G01J 2005/0081; G01J 2005/0077

(57) ABSTRACT

By combined flow of gas in the hollow component with outlet holes in a body of the component and thermographic measurement of heated air exiting the component through the outlet holes, the component can be examined. The component is examined in an apparatus in respect of its cooling air consumption and selected desired cross sections of cooling-air openings. A process is to supply gas to a gas calming chamber, convey the calmed gas into the component, and thermographically measure the gas exiting the outlet holes.

### CROSS-REFERENCE TO RELATED APPLICATIONS

The present application is a 35 U.S.C. §§371 national phase conversion of PCT/EP2013/068589, filed Sep. 9, 2013, which claims priority of European Patent Application No. 12187871.4, filed Oct. 10, 2012, the contents of which are incorporated by reference herein. The PCT International Application was published in the German language.

### TECHNICAL FIELD

The invention relates to an apparatus in which it is possible to carry out a flow measurement of hollow components having outlet openings and likewise to carry out a thermographic measurement.

### TECHNICAL BACKGROUND

Internally cooled components, such as turbine blades or vanes, having cooling-air openings, require different parameters to be examined, in order to reliably preclude failure during operation and in order to achieve guaranteed performance parameters. One important variable is the quantity of cooling air consumed, and this can be determined by means of a flow measurement. Excessively high values reduce the efficiency, while excessively low values might lead to destruction of the components as a result of overheating during operation.

Therefore, a flow measurement (air flow measurement) is carried out for each component, normally with ambient air (air quantity measurement).

A further method for quality assurance is thermographic measurement, in which hot air flows out of the component through holes and the geometry of the holes is detected by means of a thermographic measurement.

It is an object of the invention to provide an apparatus in which a hollow component can be examined in an apparatus in respect of its openings.

### BRIEF DESCRIPTION OF THE DRAWINGS

FIG. 1 shows a measurement apparatus according to the invention, and

FIG. 2 shows a turbine blade or vane.

### DESCRIPTION OF AN EMBODIMENT

The description and the figures represent only exemplary embodiments of the invention.

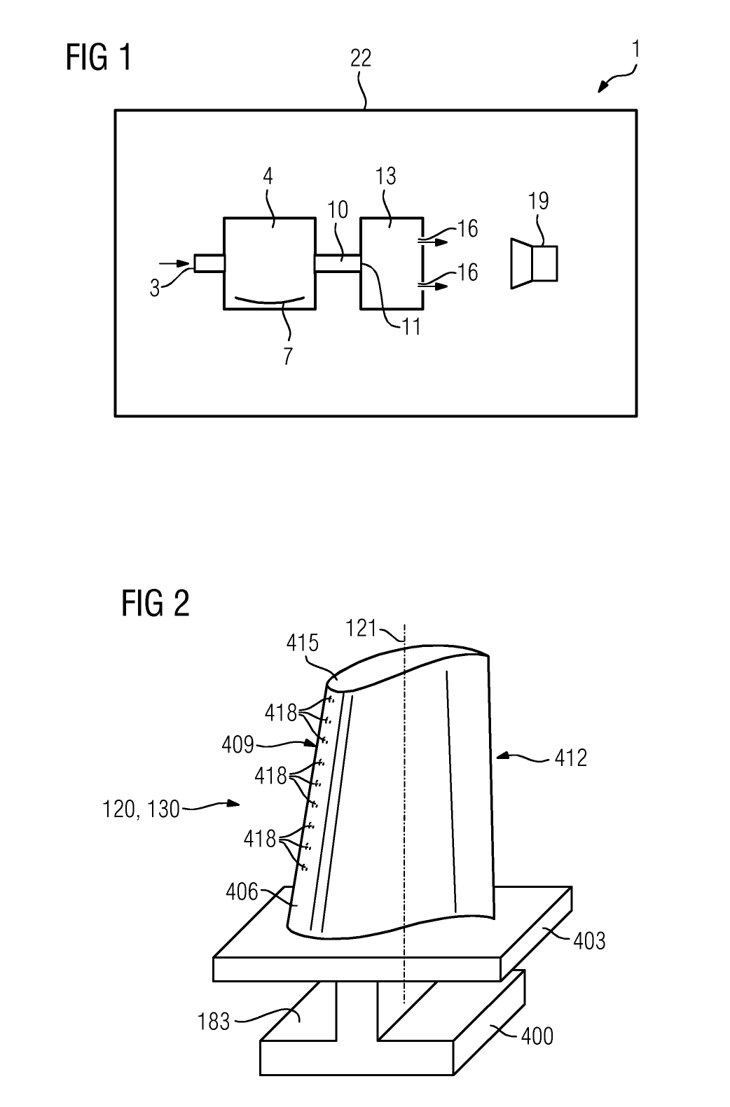

FIG. 1 shows an apparatus 1 according to the invention. The apparatus 1 preferably has an outer enclosure 22.

The component 13, 120, 130 to be measured is present within the enclosure 22 that is preferably present. The component has at least one inlet opening 11, e.g. in the case of the turbine blade or vane 120, 130, it is an opening in the blade or vane root 183, 400 (FIG. 2), at which the coolant is admitted, and outlet openings 16, (FIG. 1), that is what are termed cooling-air openings in the region of the main blade or vane part, at the trailing edge 412 (FIG. 2) in the case of a turbine blade or vane 120, 130 (FIG. 2).

For the purpose of flow measurement (air quantity measurement), a gas, in particular air, flows through an opening 3 into a calming chamber 4, which provides a uniform distribution of flow, with a fluidic connection 10 between the calming chamber 4 and the component 13. The quantity of gas (flow rate: kg/s) flowing into the calming chamber 4 is detected before inlet into the calming chamber, for example by differential pressure measurement at a nozzle or diaphragm.

The pressure in the calming chamber 4 is regulated to a constant value during the flow measurement by known means. The flow rate determined for the component 13, 120, 130 has to lie in a predefined tolerance range, if appropriate after standardization of the ambient conditions (temperature, ambient pressure).

The component 13 and the calming chamber are preferably arranged within the enclosure 22.

The component 13, 120, 130 can likewise be subjected to a thermographic measurement.

This is carried out as follows:

By means of a heating element 7 within the calming chamber 4, it is possible to heat the gas flowing into the component 13 in advance. A camera 19 within a preferably present, enclosure then takes a thermographic image from outside the component 13. This image is able to determine whether the individual cooling-air holes 16 are open and have the respective desired effective cross section.

Both the flow measurement together with the thermographic imaging of the outlet openings are combined to determine if the individual cooling air holes are open and have desired cross-section.

After the thermographic measurement has been completed, the calming chamber 4 can be cooled with unheated air.

The calming chamber 4 preferably has a thermal barrier coating on the inside, in order to avoid heating of the calming chamber 4.

An exemplary test process has the following appearance:

a. fix the component,

b. carry out the flow measurement,

c. switch on the heating element,

d. carry out the thermographic measurement with the infrared camera 19,

e. switch off the heating element,

f. cool the calming chamber 4 with air,

g. remove the component 120, 130.

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403, a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density. A protective aluminum oxide layer (TGO=thermally grown oxide layer) is formed on the MCrAlX layer (as an intermediate layer or as the outermost layer).

The layer preferably has a composition Co-30Ni-28Cr-8A1-0.6Y-0.7Si or Co-28Ni-24Cr-10A1-0.6Y. In addition to these cobalt-based protective coatings, it is also preferable to use nickel-based protective layers, such as Ni-10Cr-12A1-0.6Y-3Re or Ni-12Co-21Cr-11A1-0.4Y-2Re or Ni-25Co-17Cr-10A1-0.4Y-1.5Re.

It is also possible for a thermal barrier coating, which is preferably the outermost layer and consists for example of ZrO2, Y2O3-ZrO2, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1-5. (canceled)

6. An apparatus for the combined flow and thermographic measurement of a hollow component having openings, the apparatus comprising:
a mount or a support for the component to be measured;
a calming chamber with a gas flow inlet, the calming chamber being configured to calm the flow of gas therein and to provide a uniform distribution of the gas flow;
the calming chamber has a thermal barrier coating or a thermal insulation;
a heating element located and configured for heating the gas in the calming chamber;
a gas flow fluidic connection from the calming chamber and into the hollow component; and
an infrared camera located and configured to take thermographic images of the component and of the openings from which gas exits the component.

7. The apparatus as claimed in claim 6, further comprising an enclosure in which the mount, the calming chamber and the thermographic camera are arranged.

8. A method for combined flow measurement and thermographic measurement into and out of a component having openings, comprising:
measuring gas flow into a calming chamber and there calming the gas flow;
transmitting the gas from the calming chamber into the component; and
measuring gas out flow from the openings of the component by thermographic measurement using an infrared camera located and configured to take thermographic images of the component and of the openings from which gas exits the component.

9. The method as claimed in claim 8, comprising the following method steps:
fix the component to be measured;
carrying out the flow measurement of air into the calming chamber;
operating the heating element in the calming chamber;
carrying out the thermographic measurement on the outflow of gas exiting the openings from the gas the component using the infrared camera;
halting operation of the heating element;
cooling the interior of the calming chamber; and
removing the component.

10. The method as claimed in claim 9, further comprising:
before the flow measurement, detecting the quantity of gas and/or its flow rate into the calming chamber.

11. The method as claimed in claim 9, taking the thermographic image to determine if cooling air holes of the component are open and have a selected effective cross-section.

12. The method as claimed in claim 11, further comprising using the gas flow measurement and the thermographic imaging detection together to determine if cooling air holes of the component are open and have a selected effective cross-section.

13. The method as claimed in claim 9, wherein the gas is air.

14. The method as claimed in claim 9, wherein the interior of the calming chamber is cooled with air.
